(19) United States
(12) Patent Application Publication
(10) Pub. No.: US 2013/0128258 A1
(43) Pub. Date: May 23, 2013

(54) HELICOPTER OBSTACLE DETECTION AND INFORMATION SYSTEM

(71) Applicant: Jocke Glad, Goteborg (SE)

(72) Inventor: Jocke Glad, Goteborg (SE)

(73) Assignee: SAAB AB, Linkoping (SE)

(21) Appl. No.: 13/695,557

(22) PCT Filed: Apr. 27, 2010
(86) PCT No.: PCT/SE10/50465

§ 371 Date: Jan. 3, 2013

(51) Int. Cl. G01S 17/93

(52) U.S. Cl. CPC G01S 17/933
USPC 356/4.01

(57) ABSTRACT

A helicopter obstacle detection and information system arranged to be transmitting laser light and receiving reflected laser light from obstacles for detecting and informing the pilot of a helicopter of obstacles in proximity of the helicopter. An obstacle detection sensor unit is arranged to be mounted on a rotor head of a helicopter such that the obstacle detection sensor unit is arranged to rotate with the rotor head when mounted. The system also includes an information unit. The transmitted laser light is arranged to cover a sector volume around a rotor head axis having a coverage defined as a radial extension in a sector plane around the rotor head axis and an angular extension perpendicular to the sector plane. A communication unit is arranged for communication between the sensor unit and the information unit.

### TECHNICAL FIELD

The present invention relates to the field of helicopter obstacle detection and information systems transmitting laser light and receiving reflected laser light from obstacles for detecting and informing the pilot of a helicopter of obstacles in proximity of the helicopter.

The present invention relates to an obstacle detection sensor unit arranged to be transmitting laser light and receiving reflected laser light from said obstacles, said sensor unit being arranged to be mounted on a rotor head of a helicopter such that said obstacle detection sensor unit rotates with said rotor head when mounted, said helicopter having a longitudinal extension.

The present invention further relates to a helicopter obstacle detection and information system arranged to be transmitting laser light and receiving reflected laser light from said obstacles for detecting and informing the pilot of a helicopter of obstacles in proximity of the helicopter, comprising a sensor unit, being arranged to be mounted on a rotor head of a helicopter such that said obstacle detection sensor unit rotates with said rotor head when mounted, further comprising an information unit, said helicopter having a longitudinal extension.

### BACKGROUND

Today, there exist various examples of laser warning arrangements detecting and alarming a helicopter pilot of obstacles in the flight path when flying at a normal velocity for the helicopter. The laser warning arrangements are arranged to be able to detect and alarm for objects which are within a certain distance of the helicopter in the flight path. The purpose is to let the pilot have enough time to be able to do an evasive action of obstacles in the flight path. These present solutions are restricted to advanced and expensive equipments and lack the ability to detect and alarm for obstacles around the helicopter.

JP4276583 describes another type of known laser warning arrangement where a sensor is mounted on the rotation shaft of a helicopter and transmits a laser beam and receives reflected laser light around the helicopter. However this type of laser beam warning system is restricted to detect only in a azimuth direction around said helicopter and not in the elevation direction of said helicopter and thereby lacking the ability to detect obstacles and alarm for obstacles in a height position, above or below, of the helicopter.

There is thus a need for an improved helicopter obstacle detection and information arrangement removing the above mentioned disadvantages.

### SUMMARY

The present invention is defined by the appended independent claims. Various examples of the invention are set forth by the appended dependent claims as well as by the following description and the accompanying drawings.

With the above description in mind, then, an aspect of the present invention is to provide a simplified solution of detecting and alarming for obstacles in proximity of a helicopter which seeks to mitigate, alleviate, or eliminate one or more of the above-identified deficiencies in the art and disadvantages separately or in any combination.

The object of the present invention is to provide an inventive helicopter obstacle detection sensor unit, transmitting and receiving laser light, and a helicopter obstacle detection and information system where previously mentioned problems are partly avoided. This object is achieved by the features of claim 1 wherein, an obstacle detection sensor unit arranged to be transmitting laser light and receiving reflected laser light from obstacles, said sensor unit being arranged to be mounted on a rotor head of a helicopter such that said obstacle detection sensor unit is arranged to rotate with said rotor head when mounted, said helicopter having a longitudinal extension, characterised in that said transmitted laser light is arranged to cover a sector volume around a rotor head axis, said transmitted laser light having a coverage defined as a radial extension in a sector plane around said rotor head axis and an angular extension perpendicular to said sector plane.

Said object is further achieved by the features of claim 19 of said helicopter obstacle detection and information system, wherein an helicopter obstacle detection and information system arranged to be transmitting laser light and receiving reflected laser light from obstacles for detecting and informing the pilot of a helicopter of obstacles in proximity of the helicopter, comprising an obstacle sensor unit, being arranged to be mounted on a rotor head of a helicopter such that said obstacle detection sensor unit is arranged to rotate with said rotor head when mounted, further comprising an information unit, said helicopter having a longitudinal extension, characterised in, that said transmitted laser light is arranged to cover a sector volume around a rotor head axis, having a coverage defined as a radial extension in a sector plane around said rotor head axis and an angular extension perpendicular to said sector plane, and wherein communication means are arranged for communication between said sensor unit and said information unit.

According to a further advantageous aspect of the invention, said sector plane is perpendicular to said rotor head axis.

According to a further advantageous aspect of the invention, said sector plane is parallel to said longitudinal extension.

According to a further advantageous aspect of the invention, said sector plane is extending 360 degrees around said rotor head axis.

According to a further advantageous aspect of the invention, said coverage has an angular extension where the angle of coverage is less than 180 degrees, preferably in the range of 10 to 100 degrees, more preferably in the range of 30 to 80 degrees, most preferably in the range of 50 to 60 degrees.

According to a further advantageous aspect of the invention, said sensor unit comprises laser means, detection means and power supply means.

According to a further advantageous aspect of the invention, said laser means comprises a laser transmitter, a laser receiver and an optical assembly.

According to a further advantageous aspect of the invention, said detection means comprises a detector unit and a signal processor.

According to a further advantageous aspect of the invention, said signal processor is arranged to detect obstacles within 5 to 100 meters.

According to a further advantageous aspect of the invention, said sensor unit is arranged to be configured to enable blind zones in said coverage.

According to a further advantageous aspect of the invention, said sensor unit further comprises a scanning device arranged to scan in an angular extension perpendicular to said sector plane with said transmitted laser light.

According to a further advantageous aspect of the invention, said scanning device is arranged to establish a scanning pattern with said transmitted laser light where said scanning pattern is a grid having a mesh-like pattern.

According to a further advantageous aspect of the invention, said laser is a low risk wavelength laser with wavelengths greater than 1400 nm.

According to a further advantageous aspect of the invention, said sensor unit is mounted between the rotor blades on said rotor head.

According to a further advantageous aspect of the invention, said sensor unit is mounted on top of the rotor head above the rotor blades.

According to a further advantageous aspect of the invention, said sensor unit is mounted on the rotor head below the rotor blades.

According to a further advantageous aspect of the invention, said power supply means to said sensor unit is a battery and/or a generator.

According to a further advantageous aspect of the invention, said sensor unit is arranged to detect obstacles both when the helicopter is in flight and situated on the ground.

According to a further advantageous aspect of the invention, said information unit having information means mounted inside the helicopter for generating representation from received reflected laser light.

According to a further advantageous aspect of the invention, said information means is a visual warning.

According to a further advantageous aspect of the invention, said information means is an audible warning.

According to a further advantageous aspect of the invention, said information means is a haptic warning.

According to a further advantageous aspect of the invention, said communication means comprises electrical conductors and/or wires.

According to a further advantageous aspect of the invention, said communication means are wireless.

Any of the advantageous features of the present invention above may be combined in any suitable way.

A number of advantages are provided by means of the present invention, for example:
coverage in azimuth and elevation direction is obtained;
a complete helicopter obstacle detection and information system is obtained having wireless communication;
blind zones in the coverage is allowed;
no additional device to move the obstacle detection sensor unit or the transmitted laser light around a rotor head axis is needed;
simplified installation and maintenance is allowed;
a laser constituting a low risk for eye damage is allowed.

### BRIEF DESCRIPTION OF THE DRAWINGS

The present invention will now be described in detail with reference to the figures, wherein:

FIG. 1 schematically shows a pictorial representation of a helicopter comprising an obstacles sensor unit in accordance with the present invention.

FIG. 2 schematically shows a top plan view of a helicopter comprising an obstacles sensor unit in accordance with the present invention.

FIG. 3 schematically shows a pictorial representation of a helicopter comprising an obstacles sensor unit in accordance with the present invention.

FIG. 4 schematically shows a top plan view of a helicopter comprising an obstacles sensor unit in accordance with the present invention.

FIG. 5 schematically shows a graphic illustration of an obstacles sensor unit mounted on a rotor head.

FIG. 6 schematically shows a graphic illustration of the scan pattern generated by the scanning device.

FIG. 7 schematically shows a block diagram of the helicopter obstacles detection and information system in accordance with the present invention.

FIG. 8 schematically shows a block diagram of the obstacles sensor unit in accordance with the present invention.

It should be added that the following description of the examples is for illustration purposes only and should not be interpreted as limiting the invention exclusively to these examples/aspects.

### DETAILED DESCRIPTION

Examples of the present invention relate, in general, to the field of obstacle detection and information systems, and in particular, to helicopter obstacle detection and information systems transmitting laser light and receiving reflected laser light from obstacles for detecting and informing the pilot of a helicopter of obstacles in proximity of the helicopter.

Examples of the present invention will be described more fully hereinafter with reference to the accompanying drawings, in which examples of the invention are shown. This invention may, however, be embodied in many different forms and should not be construed as limited to the examples set forth herein. Rather, these examples are provided so that this disclosure will be thorough and complete, and will fully convey the scope of the invention to those skilled in the art. Like reference signs refer to like elements throughout.

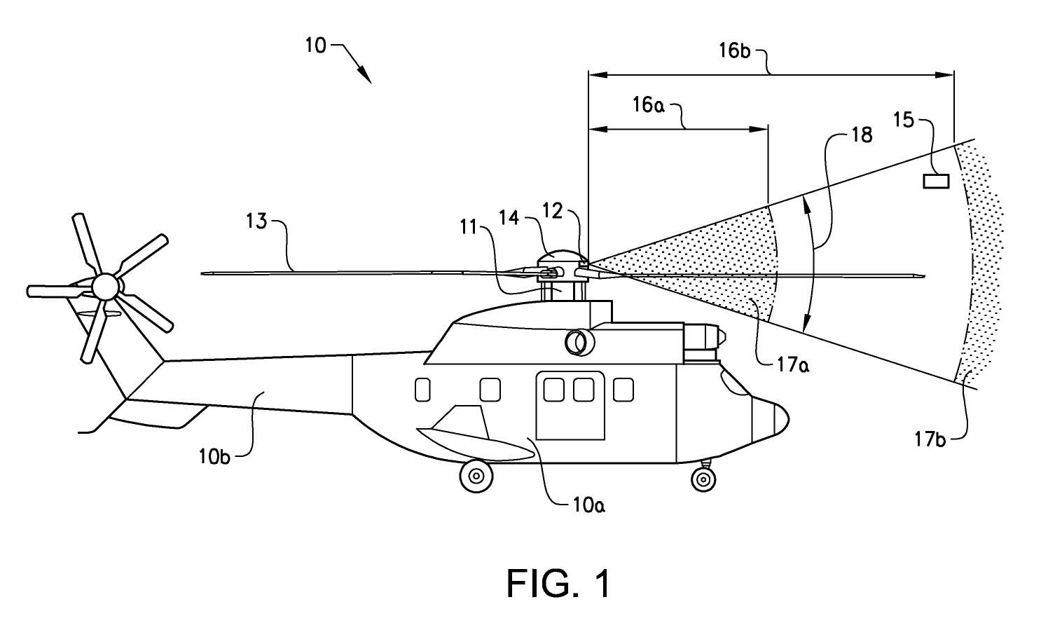

All the FIGS. 1 to 8 are schematically illustrated. FIG. 1 shows an example of the helicopter obstacle detection and information system according to the invention for detecting and informing the pilot of a helicopter 10 of an obstacle 15 in proximity of the helicopter 10. The helicopter obstacle detection and information system can detect and warn the pilot of several obstacles 15 simultaneously. The helicopter 10 has a fuselage 10a connected with a tail boom 10b. The helicopter 10 has a longitudinal extension. In the helicopter 10 is illustrated having a first rotor head 14 having first rotor blades 13. Further said helicopter 10 is illustrated having a first rotor axis 11. The helicopter obstacle detection and information system comprises an obstacle detection sensor unit 12 and an information unit, which will be further described below.

According to the present invention the first rotor head 14 further comprises the obstacle detection sensor unit 12, the first rotor head axis 11 and the first rotor blades 13.

The obstacle detection sensor unit 12 comprises laser means, detection means and power supply means. The inventive obstacle detection sensor unit 12 is to be used in the helicopter obstacle detection and information system, mounted on the first rotor head 14. The obstacle detection sensor unit 12 is mounted on the helicopter 10 such that said obstacle detection sensor unit 12 rotates with said first rotor head 14. The obstacle detection sensor unit 12 is arranged to be transmitting laser light and receiving laser light from obstacles 15 in proximity of the helicopter 10, this to cover a first sector volume around said helicopter 10 for detection of obstacles 15. The first coverage of said transmitted laser light has a first angular extension 18 perpendicular to a first sector plane, which will be further described below. The obstacles detection sensor unit 12 is mounted on the first rotor head 14 such that the obstacles detection sensor unit 12 can be removed allowing for maintenance. The obstacle detection sensor unit 12 can be mounted to the first rotor head 14 by any conventional method such as for example screwing, bolting or welding. The obstacle detection sensor unit 12 can be mounted to the first rotor head 14 by any conventional fastening means such as for example screws or bolts.

The first angular extension 18 of the transmitted laser light is selected such that the transmitted laser light substantially always covers all obstacles 15 inline, above or below and in proximity of the helicopter or the rotor blades. The laser light is transmitted having the first angular extension 18 that is less than 180 degrees, preferably in the range of 10 to 100 degrees, more preferably in the range of 30 to 80 degrees, most preferably in the range of 50 to 60 degrees. Referring to FIG. 1, the transmitted laser light having the first angular extension 18 detects obstacles in the elevation direction. The angular extension 18 of the transmitted laser light can be created and adjusted by optical lenses in the obstacle detection sensor unit 12.

The obstacle detection sensor unit 12 is arranged to detect obstacles 15 within a distance having a first minimal distance range 16a and a first maximal distance range 16b. The obstacles detection sensor unit 12 does not detect obstacles within a first inner zone 17a between the obstacle detection sensor unit 12 and the first minimal distance range 16a. The obstacles detection sensor unit 12 does not detect obstacles in a first outer zone 17b beyond the first maximal distance range 16b. Normally a laser which is safe under all conditions of normal use is used in the obstacle detection sensor unit 12 such as for example a class 1 laser; and in one example the obstacle detection sensor unit 12 is arranged to detect obstacles 15 within a distance range of 5 to 100 meters from the obstacle detection sensor unit 12, where the first minimal distance range 16a is 5 meters and the first maximal distance range 16b is 100 meters. The class 1 laser normally used constitutes a low risk for eye damage. However, all types of laser can be used in the obstacle detection sensor unit 12. The distance range for detecting the obstacle 15 is depending on the dimensions of the obstacle 15 and the effect of the transmitted laser light. However by using a more powerful laser the first maximal distance range 16b can be extended. The first minimal and maximal detection range 16a, 16b can be adjusted by said laser means and said detection means, which will be further described below.

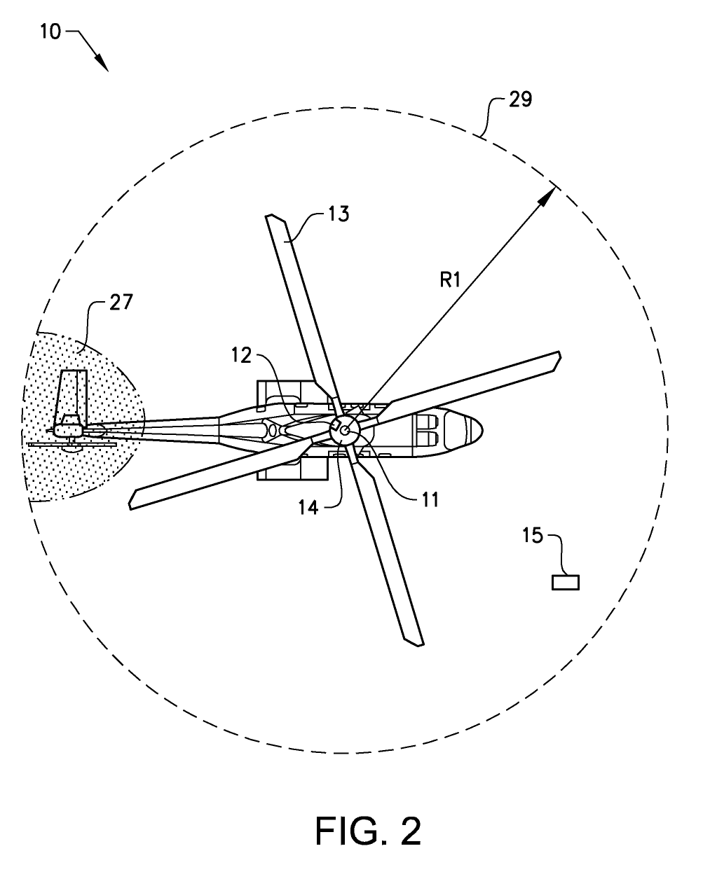

FIG. 2 shows a top plan view of the example of FIG. 1. FIG. 2 shows the first coverage of said transmitted laser light, 360 degrees around the first rotor head axis 11. The first coverage of said transmitted laser light has a first radial extension R1 in a first sector plane 29 around said first rotor head axis 11. The first sector plane 29 is perpendicular to said first rotor head axis 11. The first sector plane 29 is parallel to the longitudinal extension of the helicopter 10 which means that said first sector plane 29 is not intersecting the longitudinal extension. The first coverage of the obstacle detection sensor unit 12, when mounted on a rotating rotor head is a 3-dimensional volume defined as a first sector volume. In the example of FIGS. 1 and 2, the first coverage covers both in elevation direction and in azimuth direction 360 degrees around said helicopter 10.

FIG. 2 further schematically illustrates the obstacle detection sensor unit 12 being arranged to be configured to enable one or several blind zones 27 in the first coverage. The blind zone 27 can be adjusted to be anywhere inside the first coverage of detection. By having created blind zones 27 where the laser light detects helicopter parts, such as the fuselage 10a and the tail boom 10b, a continuous obstacle warning is not generated every time the rotating laser light passes these or other parts of the helicopter 10. The adjustment of where to position a blind zone 27 is specified in the information unit inside the helicopter. These specifications of where to position a blind zone can be changed.

For example, the blind zone 27 as shown in FIG. 2 can be created inside a data processor of the information unit, which is further described in reference to FIG. 7. Desired range and angle data of the blind zone 27 is set in the data processor. The data processor of the information unit is in communication with the obstacle detection sensor unit 12. Blind zones can be accomplished by blinding known angular position for each of the helicopter parts that the laser light will reach upon during each rotation or, alternatively, by setting a minimum range for the obstacles detection and information system which does not recognize as an obstacle the fuselage parts within the minimum range.

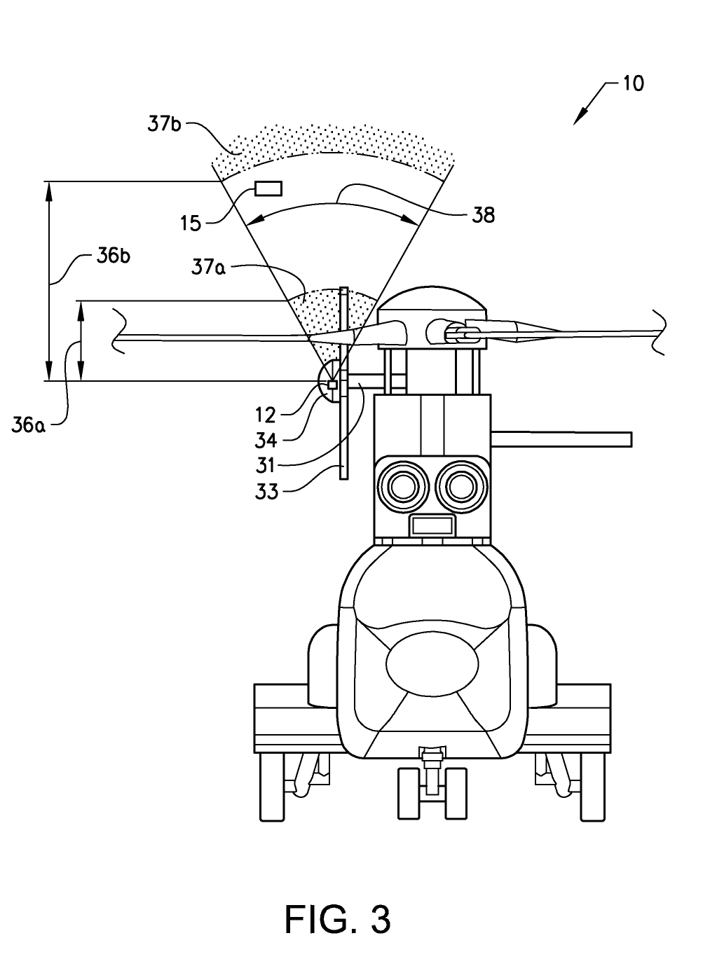

FIG. 3 shows a further example of the helicopter obstacle detection and information system according to the invention for detecting and informing the pilot of the helicopter 10 of the obstacle 15 in proximity of the helicopter 10, where the obstacle detection sensor unit 12 is mounted on a second rotor head 34 on the tail boom 10.

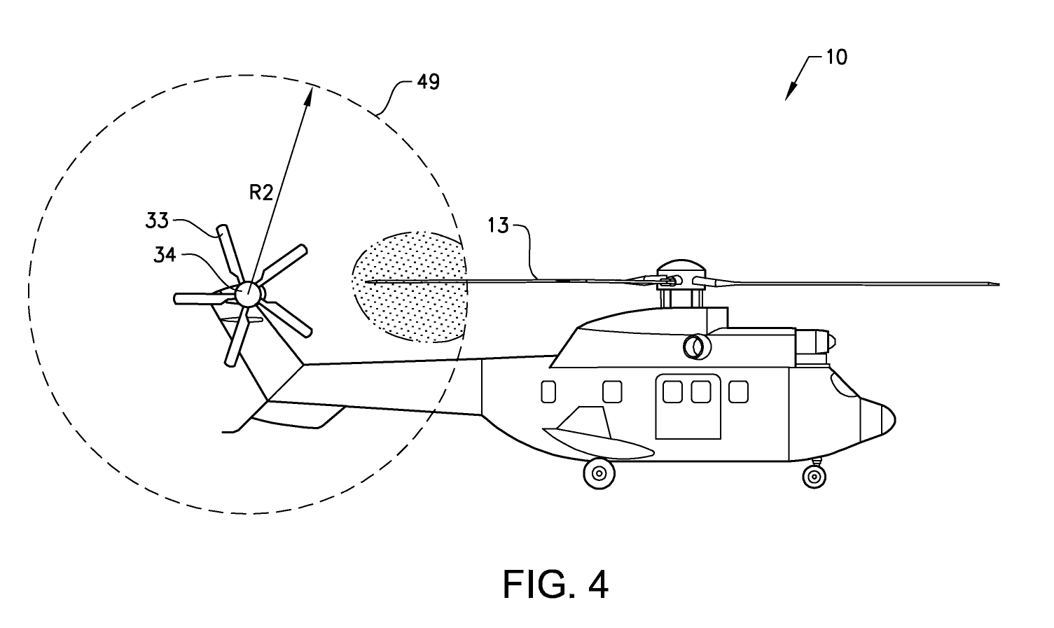

The obstacle detectionsensor unit 12 comprises laser means, detection means and power supply means mounted on the second rotor head 34. The helicopter 10 having the second rotor head 34 with second rotor blades 33. Further, said helicopter 10 is illustrated with a second rotor axis 31. The obstacle sensor unit 12 is to be used in the helicopter obstacle detection and information system, mounted on the second rotor head 34 as shown in FIGS. 3 and 4. The obstacle detection sensor unit 12 is mounted on the second rotor head 34 as is described in FIGS. 1 and 2. The obstacle detection sensor unit 12 is mounted on the rotor head 34 of the helicopter 10.

The obstacle detection sensor unit 12 is mounted on the helicopter 10 such that said obstacle detection sensor unit 12 rotates with said second rotor head 34. The obstacle detection sensor unit 12 is arranged to be transmitting laser light and receiving laser light from obstacles in proximity of the helicopter 10, this to cover a second sector volume around said second rotor head axis 31 for detection of obstacles in proximity of the helicopter. The second coverage of said transmitted laser light has a second angular extension 38. FIG. 3 shows the second angular extension 38 coverage of said transmitted laser when the obstacle detection sensor unit 12 is mounted on the second rotor head 34 on the tail boom 10b of the helicopter 10.

FIG. 3 further schematically illustrates the obstacle detection sensor unit 12 being arranged to detect obstacles 15 within a distance having a second minimal distance range 36a and a second maximal distance range 36b, where the obstacles detection sensor unit 12 does not detect obstacles within a second inner zone 37a between the obstacle detection sensor unit 12 and the second minimal distance range 36a, and where the obstacles detection sensor unit 12 does not detect obstacles in a second outer zone 37b beyond the second maximal distance range 36b, in the same manner as is described with reference to FIGS. 1 and 2.

FIG. 4 shows the second coverage of said transmitted laser light, 360 degrees around a second rotor head axis 31, illustrated in FIG. 3. The second coverage of the transmitted laser light has a second radial extension R2 in a second sector plane 49 around said second rotor head axis 31. The second coverage is a 3-dimensional volume defined as a second sector volume around said second rotor head axis 31, in the same manner as described with reference to FIGS. 1 and 2.

As illustrated in FIGS. 1 to 4, the obstacles detection sensor unit 12 can be mounted on different rotor heads on the helicopter 10. The obstacle sensor units, as shown in FIGS. 1 to 4, can operate simultaneously or individually.

The obstacle 15 shown in FIGS. 1 to 4 can constitute any type of land-, sea or air based object. The helicopter obstacle detection and information system is arranged to be configured to enable detection of one or several obstacles in proximity of the rotor blades.

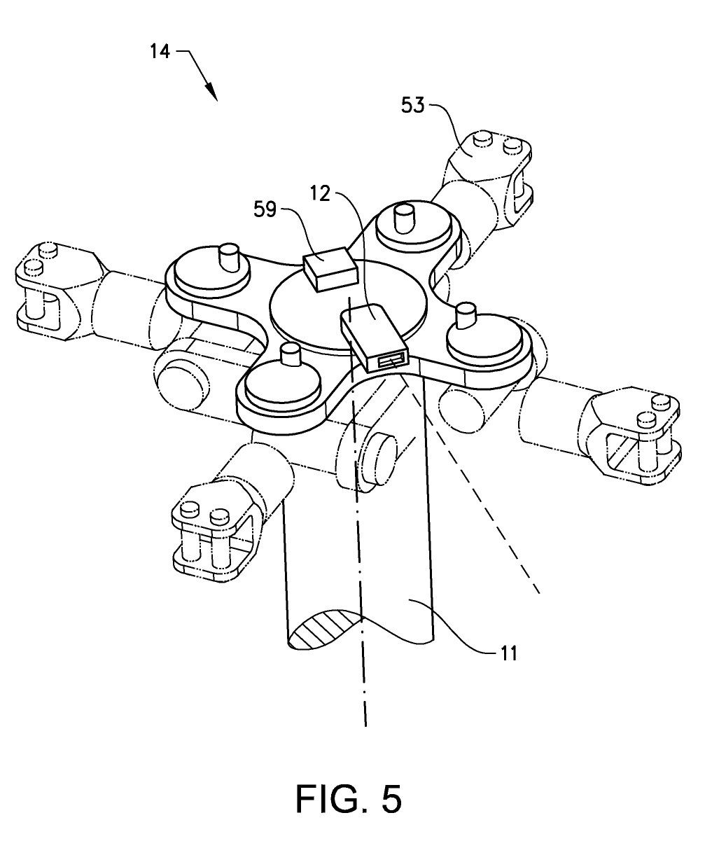

FIG. 5 shows the first rotor head 14 from the example illustrated in FIGS. 1 and 2 having the first rotor head axis 11 and rotor blade holders 53 where the first rotor blades 13 are connected to the first rotor head 14. In the example shown, the obstacle detection sensor unit 12 and a power supply means, such as a battery 59, is mounted between the rotor blades holders 53 on top of the first rotor head 14 above the rotor blade holders 53. Said battery 59 is mounted on said first rotor head 14 substantially in opposite direction to the obstacle detection sensor unit 12. However said obstacles detection sensor unit 12 and said battery 59 can be mounted at several locations on the first rotor head 14, such as for example on the first rotor head 14 below the rotor blade holders 53. The obstacle detection sensor unit 12 can also be mounted directly above, as shown in FIG. 5, below or to the side of the rotor blade holders 53. The power supply means, such as the battery 59 can also be mounted directly above, as shown in FIG. 5, below or to the side of the rotor blade holders 53. Further the power supply means can be incorporated into said obstacle detection sensor unit 12. A further example of a power supply means is a generator. Referring to FIG. 2, the first radial extension R1 is extending in a first sector plane 29 around the first rotor head axis 11. The first sector plane 29 is perpendicular to said first rotor head axis 11. The obstacles detection sensor unit 12 and the power supply means can be mounted at several locations on the second rotor head 34 in the same manner as is described with reference to FIG. 5.

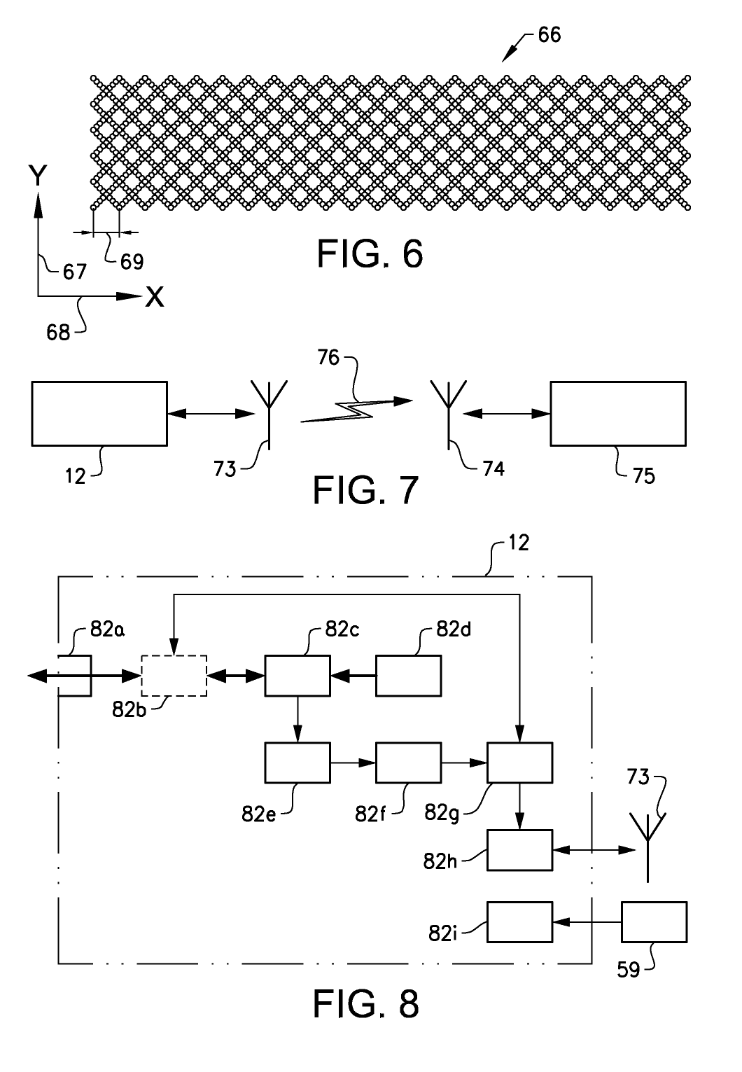

FIG. 6 shows a scanning pattern 66 which is established by the transmitted laser light during use of a laser scanning mechanism together with the obstacle detection sensor unit 12. The example in FIG. 6 is referring to an obstacle sensor unit 12 as described in FIGS. 1 and 2. The laser scanning mechanism, which will be further described in reference to FIG. 8, is arranged to scan laser light up and down in a predetermined angle area covering the first angular extension 18. This laser scanning mechanism can be used instead of or in combination with, the optical lenses, creating the first coverage in the first angular extension 18 perpendicular to the first sector plane 29.

The scanning pattern 66 is a grid having a mesh-like pattern. The scanning pattern 66 is established when the laser scanning mechanism attached on the first rotor head 14, or integrated with the obstacle detection sensor unit 12, scans up and down in the first angular extension 18 perpendicular to the first sector plane 29 with the transmitted laser light and simultaneously rotates around the first rotor head axis 11. In the example shown in FIG. 6, the laser scanning mechanism is used for scanning and detecting in both elevation and azimuth direction around the first rotor head axis 11. Referring to FIG. 6, elevation direction is represented by the Y-axis 67 and the azimuth direction is represented by the X-axis 68. The scan pattern distance 69 which is illustrated in FIG. 6 shows the mesh size and the resolution of the scanning pattern 66 which are created depending on the velocity of the laser scanning mechanism scanning up and down and the rotational velocity of the first rotor head 14. The scanning pattern 66 and the scan pattern distance 69 depends on the velocity in the elevation direction of the laser scanning mechanism and the rotational velocity of the first rotor head 14. The scan pattern distance 69 can differ in size dependent on the velocity of the laser mechanism and the rotational velocity. The use of a laser scanning mechanism reduces the amount of power needed to scan and cover the first sector volume around the first rotor blades 13 of the first rotor head 14. In the same manner as is described with reference to FIG. 6 an obstacle detection sensor unit 12 mounted on the second rotor head 34 can establish a second scanning pattern.

FIG. 7 shows the inventive helicopter detection and information system comprising the obstacle detection sensor unit 12 with a first antenna 7 and an information unit 75 with a second antenna 74. The obstacle sensor unit 12 and the information unit 75 have communications means. The communication means can be wireless. Referring to FIG. 7, the communication between the obstacles detection sensor unit 12 and the information unit 75 is a wireless communication 76. The obstacle sensor unit 12 and the information unit 75 communicate with each other through the first antenna 73 and the second antenna 74. However, the communication means can comprise electrical conductors or wires. The communication means can constitute a combination of wireless communication and electrical conductors or wires. The complete obstacle detection sensor unit 12 with integrated power supply and without additional electrical conductors or wires for communication simplifies installation and maintenance.

Referring to FIG. 7, the first antenna 73 is in connection with the obstacle detection sensor unit 12 and can be incorporated in the obstacle detection sensor unit 12 or mounted separate from the obstacle sensor unit 12 on the helicopter 10. The second antenna 74 is in connection with the information unit 75 and can be incorporated in the information unit 75 or be a separate unit mounted on the helicopter 10. The information unit 75 has information means mounted inside the helicopter 10 for generating representation from received laser light. The information means can be a visual warning or an audible warning or a haptic warning to the pilot of the helicopter 10. The information unit 75 comprises various electronic equipments such as a data processor, interface circuit, wireless link and display unit.

FIG. 8 schematically shows a block diagram of the obstacle detection sensor unit 12. In the example shown, the obstacle sensor unit comprises a window 82a, a scanning mechanism 82b, an optical assembly 82c, a laser transmitter 82d, a laser receiver 82f, a detector 82e, a signal processor 82g, a wireless link 82h, a power converter 82i, a power supply means, such as a battery 59 and an antenna 73. The power supply means can be a generator.

Referring to FIG. 8, the laser means comprises the laser transmitter 82d, the laser receiver 82f and the optical assembly 82c. The laser transmitter 82d is adapted to transmit laser light. The laser receiver 82f is adapted to receive reflected laser light. The optical assembly 82c is adapted to emit laser light with a pre-determined angle. The angle of the laser light can be adjusted by optical lenses. The optical assembly 82c can comprise optical lenses. The optical lenses determine the angle of the laser light transmitted having an angular extension 18, 38. The optical assembly 82c is capable of emitting the laser light trough optical lenses creating an angle in the laser light with optical lenses. The laser light is transmitted and received through the window 82a of the obstacle detection sensor unit 12.

As illustrated in FIG. 8, laser light is transmitted from the laser transmitter 82d to the optical assembly 82c and then to the scanning mechanism 82b and then out through the window 82a of the obstacle detection sensor unit 12 covering an angular extension 18, 38 with the transmitted laser light. The scanning mechanism shown in FIG. 8 is an optional part of the obstacle detection sensor unit 12, it can be omitted. In the example with the scanning mechanism the transmitted laser light is a laser beam and the angular extension 18, 38 is created by the laser light being scanned up and down using the scanning mechanism which directs the laser light up and down.

Further the detection means comprises a detector unit 82f and a signal processor 82g. The detector unit 82f can be any suitable photo detector, such as a discrete photo detector or a photo detector array. The photo detector may comprise several photo elements or may be an analogue detector. In this way, the elevation position may be detected. The signal processor 82g is in communication with the scanning mechanism 82b and controls the scanning mechanism. The signal processor is in communication with the detector 82f and the wireless link 82h which is in communication with the first antenna 73.

The timing of the received laser light and the position of the obstacle detection sensor unit 12 is synchronized in a suitable way, for example by having a fix point on the fuselage 10a or the tail boom or any other fix point. The obstacle detection sensor unit 12 receives laser light from obstacles and the position of the obstacles is calculated trough a comparison of the angle between the position of the obstacle detection sensor unit 12 and the reference point. The transmitted laser light from the obstacle detection sensor unit 12 will reach the fix point indicating the rotational position of the obstacle detection sensor unit 12. The rotational position of the obstacle detection sensor unit 12 is calculated by having said fix point as a reference point and the rotational velocity. The reference point can also be obtained by a position sensor of the rotor head axis indicating the rotational position of the obstacle detection sensor unit 12.

The invention is not limited to the example described above, but may be modified without departing from the scope of the claims below.

The terminology used herein is for the purpose of describing particular examples only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

The foregoing has described the principles, preferred examples and modes of operation of the present invention. However, the invention should be regarded as illustrative rather than restrictive, and not as being limited to the particular examples discussed above. The different features of the various examples of the invention can be combined in other combinations than those explicitly described. It should therefore be appreciated that variations may be made in those examples by those skilled in the art without departing from the scope of the present invention as defined by the appended claims.

1. An obstacle detection sensor unit (12) arranged to transmit laser light and receive reflected laser light from obstacles (15), said obstacle detection sensor unit (12) is arranged to be mounted on a rotor head (14, 34) of a helicopter (10) such that said obstacle detection sensor unit (12) is arranged to rotate with said rotor head (14, 34) when mounted, said helicopter (10) having a longitudinal extension, characterised in that said transmitted laser light is arranged to cover a sector volume around a rotor head axis (11, 31), said transmitted laser light having a coverage defined as a radial extension (R1, R2) in a sector plane (29, 49) around said rotor head axis (11, 31) and an angular extension (18, 38) perpendicular to said sector plane (29, 49).

2. The obstacle detection sensor unit (12) according to claim 1, characterised in that said sector plane (29, 49) is perpendicular to said rotor head axis (11, 31).

3. The obstacle detection sensor unit (12) according to any of claim 2, characterised in that said sector plane (29, 49) is parallel to said longitudinal extension.

4. The obstacle detection sensor unit (12) according to any of the preceding claims, characterised in that said sector plane (29, 49) is extending 360 degrees around said rotor head axis (11, 31).

5. The obstacle detection sensor unit (12) according to any of the preceding claims, characterised in, that said coverage has an angular extension (18, 38) where the angle of coverage is less than 180 degrees, preferably in the range of 10 to 100 degrees, more preferably in the range of 30 to 80 degrees, most preferably in the range of 50 to 60 degrees.

6. The obstacle detection sensor unit (12) according to any of the preceding claims, characterised in, that said sensor unit (12) comprises laser means, detection means and power supply means.

7. The obstacle detection sensor unit (12) according claim 6, characterised in, that said laser means comprises a laser transmitter (82d), a laser receiver (82f) and an optical assembly (82c).

8. The obstacle detection sensor unit (12) according claim 6, characterised in, that said detection means comprises a detector unit (82e) and a signal processor (82g).

9. The obstacle detection sensor unit (12) according to any of the preceding claims, characterised in, that said signal processor (82g) is arranged to detect obstacles within 5 to 100 meters.

10. The obstacle detection sensor unit (12) according to any of the preceding claims, characterised in that said sensor unit (12) is arranged to be configured to enable blind zones (27) in said coverage.

11. The obstacle detection sensor unit (12) according to any of the preceding claims, characterised in that said sensor unit (12) further comprises a scanning mechanism (82b) arranged to scan in an angular extension (18, 38) perpendicular to said sector plane (29, 49) with said transmitted laser light.

12. The obstacle detection sensor unit (12) according to claim 11, characterised in said scanning mechanism (82b) is arranged to establish a scanning pattern (66) with said transmitted laser light where said scanning pattern (66) is a grid having a mesh-like pattern.

13. The obstacle detection sensor unit (12) according to any of the preceding claims, characterised in that said laser is a low risk wavelength laser with wavelengths greater than 1400 nm.

14. The obstacle detection sensor unit (12) according to any of the preceding claims, characterised in that said sensor unit (12) is arranged to be mounted between the rotor blades (13, 33) on said rotor head (14, 34).

15. The obstacle detection sensor unit (12) according to any of the preceding claims, characterised in that said sensor unit (12) is arranged to be mounted on top of the rotor head (14, 34) above the rotor blades (13, 33).

16. The obstacle detection sensor unit (12) according to any of the claims 1-14, characterised in, that said sensor unit (12) is arranged to be mounted on the rotor head (14, 34) below the rotor blades (13, 33).

17. The obstacle detection sensor unit (12) according to any of the preceding claims, characterised in that said power supply means to said sensor unit (12) is a battery (59) and/or a generator.

18. The obstacle detection sensor unit (12) according to any of the preceding claims, characterised in that said sensor unit (12) is arranged to detect obstacles (15) both when the helicopter (10) is in flight and situated on the ground.

19. An helicopter obstacle detection and information system arranged to be transmitting laser light and receiving reflected laser light from obstacles (15) for detecting and informing the pilot of a helicopter (10) of obstacles (15) in proximity of the helicopter (10), comprising an obstacle detection sensor unit (12), being arranged to be mounted on a rotor head (14, 34) of a helicopter (10) such that said obstacle detection sensor unit (12) is arranged to rotate with said rotor head (14, 34) when mounted, further comprising an information unit (75), said helicopter (10) having a longitudinal extension, characterised in that said transmitted laser light is arranged to cover a sector volume around a rotor head axis (11, 31), having a coverage defined as a radial extension (R1, R2) in a sector plane (29, 49) around said rotor head axis (11, 31) and an angular extension (18, 38) perpendicular to said sector plane (29, 49), and wherein communication means are arranged for communication between said sensor unit (12) and said information unit (75).

20. The system according to claim 19, characterised in that said sector plane (29, 49) is perpendicular to said rotor head (14, 34).

21. The system according to any of the claims 19-20, characterised in that said sector plane (29, 49) is parallel to said longitudinal extension.

22. The system according to any of the claims 19-21, characterised in that said sector plane (29, 49) is extending 360 degrees around said rotor head axis (11, 31).

23. The system according to any of the claims 19-22, characterised in that said coverage having an angular extension (18, 38) where the angle of coverage is less than 180 degrees, preferably in the range of 10 to 100 degrees, more preferably in the range of 30 to 80 degrees, most preferably in the range of 50 to 60 degrees.

24. The system according to any of the claims 19-23, characterised in that said obstacle detection sensor unit (12) is arranged to be configured to enable blind zones (27) in said coverage.

25. The system according to any of the claims 19-24, characterised in that said information unit (75) having information means mounted inside the helicopter (10) for generating representation from received reflected laser light.

26. The system according to claim 25, characterised in that said information means is a visual warning.

27. The system according to claim 26, characterised in that said information means is an audible warning.

28. The system according to claim 27, characterised in that said information means is a haptic warning.

29. The system according to any of the claims 19-28, characterised in that said communication means comprises electrical conductors and/or wires.

30. The system according to any of the claims 19-28, characterised in that said communication means are wireless.

31. The system according to any of the claims 19-30, characterised in that said obstacle detection sensor unit (12) is arranged to detect obstacles (15) both when the helicopter (10) is in flight and situated on the ground.
